(19) United States
(12) Patent Application Publication
(10) Pub. No.: US 2010/0290808 A1
(43) Pub. Date: Nov. 18, 2010

(54) Electrophotographic Photoreceptor and Image Formation Apparatus

(75) Inventor: Akihiko Itami, Tokyo (JP)

Correspondence Address: SQUIRE, SANDERS & DEMPSEY L.L.P., 275 BATTERY STREET, SUITE 2600, SAN FRANCISCO, CA, 94111-3356, US

(73) Assignee: KONICA MINOLTA BUSINESS TECHNOLOGIES, INC., Tokyo (JP)

(21) Appl. No.: 12/808,155

(22) PCT Filed: Jul. 16, 2009
(86) PCT No.: PCT/JP2009/062872

§ 371 Date: Jun. 14, 2010

(30) Foreign Application Priority Data
Aug. 25, 2008 (JP) 2008-215153

(51) Int. Cl. G03G 15/00

(52) U.S. Cl. 399/159; 430/58.05

(57) ABSTRACT

The present invention is characterized in that an electrophotographic photoreceptor comprises an electrically conductive support and provided thereon, a charge generation layer and a charge transport layer in that order, wherein the charge transport layer contains a resin having a repeating unit represented by the following formula (1), a charge transport material represented by the following formula (2), and an ultraviolet absorbent in an amount of from 0.1 to 30.0% by weight based on the weight of the charge transport material, and can provide an organic photoreceptor exhibiting high thin line reproduction, employing a small diameter exposure light spot, and excellent durability capable of forming a stable image for a long period, wherein even when an image is repeatedly formed at high speed, exposure electric potential variation is reduced and image memory generation is prevented, and an image formation apparatus employing the organic photoreceptor.

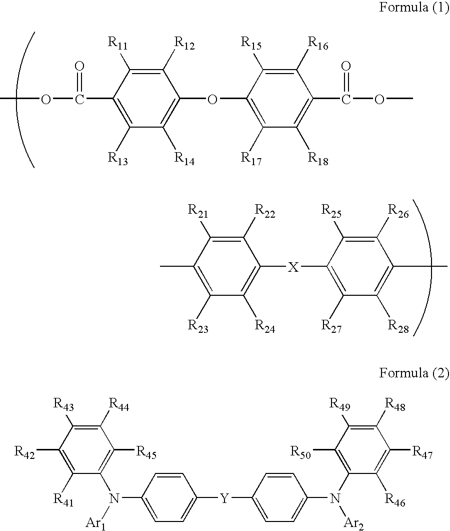

### FIELD OF THE INVENTION

The present invention relates to an electrophotographic photoreceptor used in a copier or printer employing image formation according to an electrophotographic process and an image formation apparatus provided with the electrophotographic photoreceptor.

### TECHNICAL BACKGROUND

In recent years, an organic photoreceptor has been widely used as an electrophotographic photoreceptor. The organic photoreceptor has advantages as compared with other photoreceptors, in that materials meeting various exposure light sources emitting visible to infrared light are easy to develop, materials with less environmental pollution can be selected, and the manufacturing cost is low. However, the organic photoreceptor has problem in mechanical strength or chemical resistance and problem in that when many copies are printed, static property deteriorates or scratches occur on the surface thereof.

Since external electrical or mechanical force is directly applied to the organic photoreceptor by a charging device, a developing device, a transfer device or a cleaning device, mechanical durability to abrasion or scratches of the organic photoreceptor has been required. Further, chemical resistance to the surface property deterioration due to a nitrogen oxide or an activated oxygen such as ozone generated during corona charging is also necessary.

In order to solve the problem of the mechanical or chemical resistance as described above, the constitution of many electrophotographic photoreceptors is such that a charge generation layer and a charge transport layer are separately provided so that the charge transport layer is an outer surface layer, and such that the charge transport layer is a uniform layer, which is high in mechanical strength and difficult to transmit activated gases, and has a thickness of 20 μm or more.

However, when the thickness of the charge transport layer is increased to obtain a large allowance and high durability, charge trap in the charge transport layer is also increased. Therefore, particularly when an image is repeatedly formed at high speed, residual electric potential increases and charging electric potential lowers, which makes it difficult to obtain a sharp image with high contrast.

Recently, an image formation apparatus employing an electrophotographic process has been used rather in the field called on-demand printing in which repeated image formation at high speed is carried out, than in an office. Accordingly, this problem is one to be solved.

In view of the above, many techniques have been studied which improve high speed stability or repetition properties of a photoreceptor. As a method for improving high speed stability or repetition properties of an electrophotographic photoreceptor, a study has been made on a polymer charge transport material or addition of additives to a charge transport layer.

A technique is known which obtains an electrophotographic photoreceptor with high durability, high sensitivity, and excellent electric potential stability during repeated use employing a charge transport layer containing a specific binder resin and a specific charge transport material (see Patent Document 3).

However, even when an image is formed repeatedly and many copies are printed, employing these techniques, satisfactory results are not obtained in stability of sensitivity property during the repeated use.

As described above, satisfactory results have not still been obtained in stability of sensitivity property during the repeated use, which an electrophotographic photoreceptor is required.

### PRIOR ART LITERATURES

### Patent Documents

### Patent Document 1: Japanese Patent O.P.I. Publication No. 2001-142241

### Patent Document 2: Japanese Patent O.P.I. Publication No. 2005-140948

### Patent Document 2: Japanese Patent O.P.I. Publication No. 2007-272175

### DISCLOSURE OF THE INVENTION

### Problems to be Solved by the Invention

An object of the invention is to provide an organic photoreceptor providing a high quality image and stable sensitivity property in repeated image formation at high speed. Another object of the invention is to provide an electrophotographic photoreceptor exhibiting high thin line reproduction, employing a small diameter exposure light spot, and excellent durability capable of forming a stable image for a long period, wherein even when an image is repeatedly formed at high speed, exposure electric potential variation is reduced and image memory generation is prevented, and an image formation apparatus employing the electrophotographic photoreceptor.

### Means for Solving the Above Problems

It is known that incorporation of a resin having a repeated unit represented by formula (1) as a binder resin in a charge transport layer is advantageous to form a high quality image, since the resin has high compatibility with a charge transport material and excellent transmissibility of exposure light. However, it has been found that there is problem in that charging property deteriorates and image memory is likely to occur, regarding the durability when repeated image formation at high speed is carried out and many copies are printed in the recent on-demand printing field. Study has been made in order to solve this problem, and as a result, it has been found that the problem can be solved by addition of an ultraviolet absorbent in an amount of 0.1 to 30.0% by weight based on the weight of a charge transport material. Further, it has been found that the addition exhibits the effects of the invention even when an image is repeatedly formed at high speed, employing a 380 to 450 nm semiconductor laser or light-emitting diode as a writing light source, which is considered to provide large load to an electrophotographic photoreceptor.

The above object of the invention can be attained by any one of the following constitutions.

1. An electrophotographic photoreceptor comprising an electrically conductive support and provided thereon, a charge generation layer and a charge transport layer in that order, wherein the charge transport layer contains a resin having a repeating unit represented by the following formula (1), a charge transport material represented by the following formula (2), and an ultraviolet absorbent in an amount of from 0.1 to 30.0% by weight based on the weight of the charge transport material,

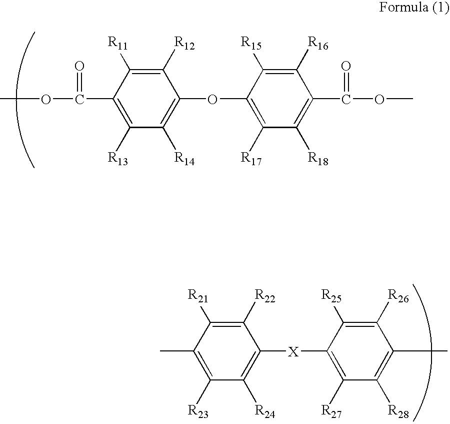

wherein R₁₁ through R₁₈ and R₂₁ through R₂₈ independently represent a hydrogen atom, an alkyl group, an aryl group or an alkoxy group; X represents a simple bond, an oxygen atom, a sulfur atom, or a divalent group having a structure represented by the formula (A),

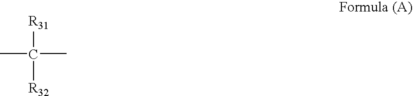

wherein R₃₁ and R₃₂ independently represent a hydrogen atom, an alkyl group, a fluorinated alkyl group, an aryl group or an alkoxy group, or R₃₁ and R₃₂ combine with each other to form a cycloalkylidene group or a fluorenylidene group,

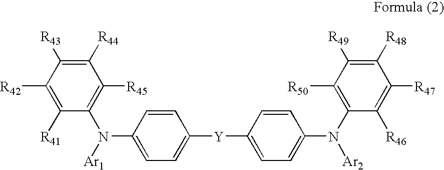

wherein R₄₁ through R₅₀ independently represent a hydrogen atom, an alkyl group, an aryl group or an alkoxy group; Ar₁ and Ar₂ independently represent an aromatic hydrocarbon group which may have a substituent; Y represents a divalent group having a structure represented by the following formula (B),

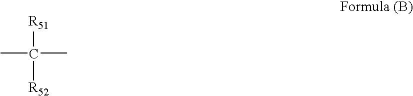

wherein R₅₁ and R₅₂ independently represent a hydrogen atom, an alkyl group, a fluorinated alkyl group, an aryl group or an alkoxy group, or R₅₁ and R₅₂ combine with each other to form a cycloalkylidene group or a fluorenylidene group.

2. The electrophotographic photoreceptor of item 1 above, wherein the ultraviolet absorbent has an absorption peak in the wavelength region of from 325 to 390 nm.

3. The electrophotographic photoreceptor of item 2 above, wherein the ultraviolet absorbent is a benzotriazole ultraviolet absorbent, a benzophenone ultraviolet absorbent or a triazine ultraviolet absorbent

4. The electrophotographic photoreceptor of item 3 above, wherein the thickness of the charge transport layer is from 10 to 30 μm.

5. The electrophotographic photoreceptor of any one of items 1 through 4 above, wherein the charge generation layer contains a charge generation material which is an azo pigment, a perylene pigment or a polycyclic quinone pigment

6. The electrophotographic photoreceptor of item 5 above, wherein the thickness of the charge generation layer is from 0.3 to 2 μm.

7. An image formation apparatus which repeatedly forms an image, the image formation apparatus comprising an electrophotographic photoreceptor, and provided at the circumference of the electrophotographic photoreceptor, at least a charging device, an exposing device and a developing device, wherein the exposing device is a digital mode imagewise exposing device employing a semiconductor laser or a light-emitting diode and the electrophotographic photoreceptor is the electrophotographic photoreceptor of item 1 above.

8. The image formation apparatus of item 7 above, wherein the wavelength of the semiconductor laser or the light-emitting diode is from 380 to 450 nm.

### EFFECTS OF THE INVENTION

The present invention can provide an organic photoreceptor exhibiting high thin line reproduction, employing a small diameter exposure light spot, and excellent durability capable of forming a stable image for a long period, wherein even when an image is repeatedly formed at high speed, exposure electric potential variation is reduced and image memory generation is prevented, and an image formation apparatus employing the organic photoreceptor.

### BRIEF DESCRIPTION OF THE DRAWING

FIG. 1 is a sectional view of a color image formation apparatus capable of being provided with the electrophotographic photoreceptor of the invention.

### EMBODIMENT FOR CARRYING OUT THE INVENTION

Next, the present invention will be explained in detail.

The present invention is attained by an electrophotographic photoreceptor comprising an electrically conductive support and provided thereon, at least a charge generation layer, a charge transport layer and a protective layer in that order, wherein the charge transport layer contains a resin having a repeating unit represented by formula (1) above, a charge transport material represented by formula (2) above, and an ultraviolet absorbent in an amount of from 0.1 to 30.0% by weight based on the weight of the charge transport material.

The reason that the effects of the invention can be obtained by the above constitution is considered as follows.

The resin having a repeated unit represented by formula (1) above has high compatibility with a charge transport material, particularly with a charge transport material represented by formula (2) above and has high transmissibility of exposure light, while since irradiation of exposure light to the charge transport material is relatively high, deterioration of the charge transport material due to repeated exposure proceeds and charge traps are likely to be formed.

In most case, light causing such deterioration is ultraviolet light with high energy. When a charge transport layer is irradiated with exposure light, the ultraviolet absorbent contained in the charge transport layer absorbs the exposure light which has been absorbed by a binder resin before. Therefore, it is considered that deterioration of the charge transport material is effectively prevented while maintaining high transmissibility to exposure light.

Marked effects are exhibited on prevention of an image memory (so-called transfer memory) accompanied by application of reverse bias voltage during image transfer, but the reason is unclear. It is supposed that absorption of exposure light by components in a charge transport layer relate to transfer memory generation mechanism, in which rather the ultraviolet absorbent than the binder resin or the charge transport material in the charge transport layer positively absorbs the harmful exposure light components and inactivates to other energies.

Next, the present invention will be further explained in detail.

The electrophotographic photoreceptor of the invention is a photoreceptor comprising an electrically conductive support, and provided thereon, a charge generation layer and a charge transport layer.

The charge transport layer contains a binder resin. In the invention, the charge transport layer contains, as the binder resin, a resin represented by the following formula (1).

In formula (1), R₁₁ through R₁₈ and R₂₁ through R₂₈ independently represent a hydrogen atom, an alkyl group, an aryl group or an alkoxy group; X represents a simple bond, an oxygen atom, a sulfur atom or a divalent group having a structure represented by the following formula (A).

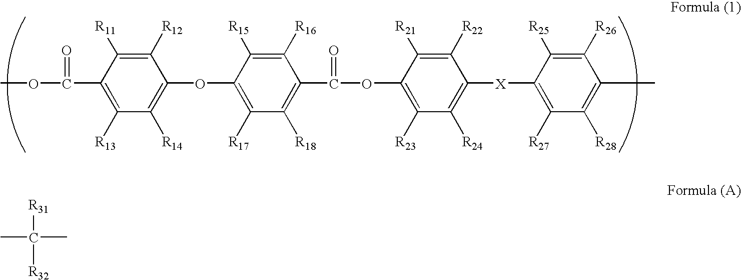

In formula (A), R₃₁ and R₃₂ independently represent a hydrogen atom, an alkyl group, a fluorinated allyl group, an aryl group or an alkoxy grow, or R₃₁ and R₃₂ combine with each other to form a cycloalkylidene group or a fluorenylidene group.

In R₁₁ through R₁₈ and R₂₁ through R₂₈ of formula (1) above, examples of the alkyl group of include a methyl group, an ethyl group, a propyl group and a butyl group; examples of the alkoxy group include a methoxy group, an ethoxy group, and a propoxy group; and examples of the aryl group include a phenyl group and a naphthyl group. Among these, a methyl group, an ethyl group, a methoxy group and a phenyl group are preferred.

In R₃₁ and R₃₂ of formula (A), examples of the alkyl group include a methyl group, an ethyl group, a propyl group and a butyl group; examples of the fluorinated alkyl group include a trifluoromethyl group and a pentafluoroethyl group; examples of the alkoxy group include a methoxy group, an ethoxy group, a propoxy group and a butoxy group; examples of the aryl group include a phenyl group and a naphthyl group. Among these, a methyl group, an ethyl group, a propyl group (particularly an isopropyl group), a trifluoromethyl group and a pentafluoroethyl group are preferred.

In formula (A), examples of the cycloalkylidene group which R₃₁ and R₃₂ combine with each other to form include a cyclopentylidene group, a cyclohexylidene group and a cycloheptylidene group. Among these, a cyclohexylidene group is preferred.

Examples of the repeating structure unit represented by formula (1) above will be listed below.

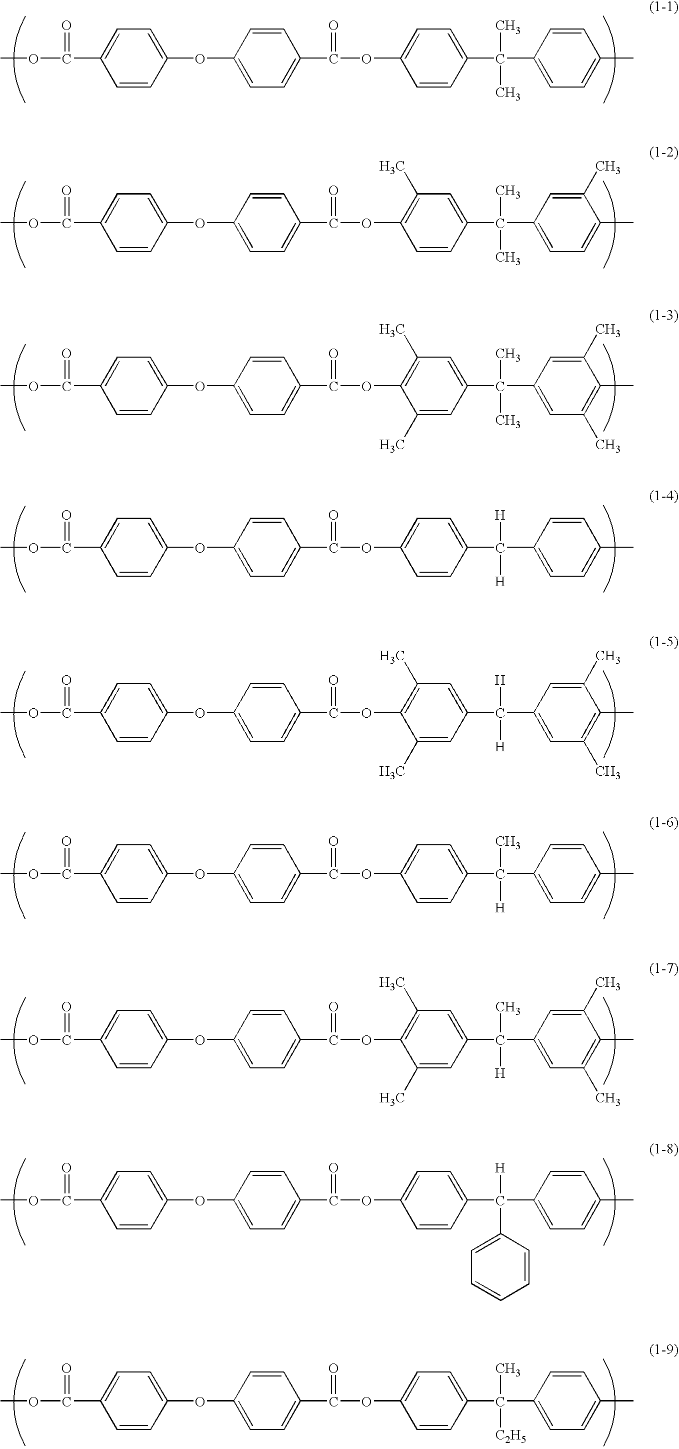

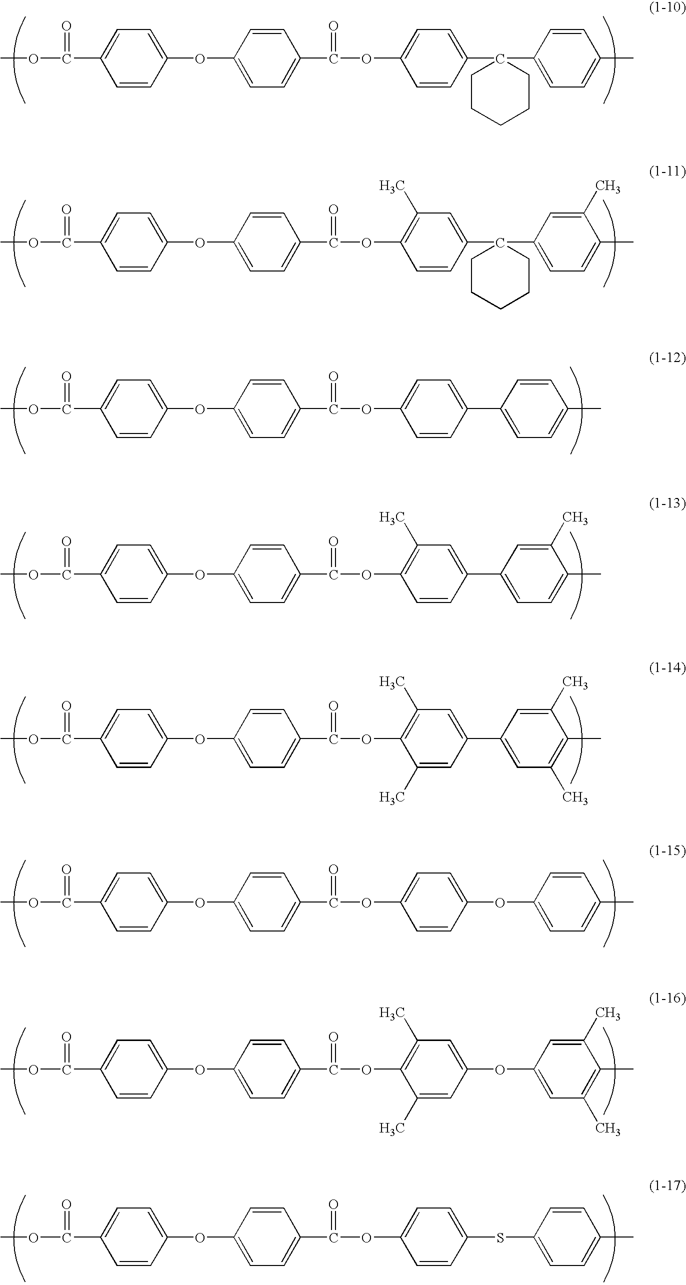

In the resin having a repeating unit represented by formula (1) above used in the charge transport layer of the electrophotographic photoreceptor of the invention, the content of the repeating unit in the resin is from 60 to 100% by mole based on the total repeating structure units of the resin. The content of the repeating unit in the resin is preferably not less than 80% by mole, and more preferably not less than 90% by mole, based on the total repeating structure units of the resin, in view of increase in mechanical strength.

The resin having a repeating unit represented by formula (1) above can be a copolymer of a specific repeating unit represented by formula (1) above and another repeating unit represented by formula (1) above or a copolymer of a specific repealing unit represented by formula (1) above and another repeating unit composed of another dicarboxylic acid and a divalent organic residue. In this case, the copolymer obtained by copolymerization process may be a random copolymer or a blocked copolymer, but a random polymer is preferred.

A polymerization terminating agent being added during polymerization, the resin having a repeating unit represented by formula (1) above preferably has, in the molecule end, the terminating agent molecule. The terminating agent is arbitrarily selected from compounds generally used (for example, 4-tertiarybutylphenol, etc.).

In order to prepare the resin in the invention, known methods can be employed but an interface polymerization is especially preferred. In the interface polymerization, an aqueous alkali solution, in which at least one kind of bifunctional phenol component, at least one bisphenol component or at least one diol component is dissolved, is mixed with a halogenated hydrocarbon solution, in which one or more kinds of an aromatic dicarboxylic acid are dissolved.

At this time, it is possible to add a quaternary ammonium salt or a quaternary phosphonium salt as a catalyst. The polymerization temperature is preferably in the range of from 0 to 40° C., and the polymerization time is preferably in the range of from 2 to 12 hours, in view of productivity. After polymerization, the organic phase is separated from the water phase, and washed. A polymer is extracted from the washed organic phase in which the polymer is dissolved according to a known method. Thus, an intended resin is obtained.

As an alkali component used herein, there is an alkali metal hydroxide such as sodium hydroxide or potassium hydroxide. The amount used (by equivalent amount) of the alkali component is preferably from 1.0 to 3 times that of a phenolic hydroxyl group in the reaction solution. As a halogenated hydrocarbon used herein, there is dichloromethane, chloroform, 1,2-dichloroethane, trichloroethane, tetrachloroethane or dichlorobenzene.

Examples of the quaternary ammonium salt or quaternary phosphonium salt used as a catalyst include a salt of a trialkyl amine such as tributylamine or trioctylamine with hydrochloric acid, a bromic acid or an iodic acid, and benzyltriethylammonium chloride, benzytrimethylammonium chloride, benzyltributylammonium chloride, tetraethylammonium chloride, tetrabutylammonium chloride, tetrabutylammonium bromide, trioctylmethylammonium chloride, tetrabutylphosphonim chloride, triethyloctadecylphosphonim bromide, N-laurylpyridinium chloride and laurylpicolinium chloride.

A method for purifying the resin after polymerization may be a method in which the resin solution is washed with an alkali solution of sodium hydroxide or potassium hydroxide, an acid solution of hydrochloric acid, nitric acid or phosphoric acid or water, allowed to stand, and then subjected to centrifuge. Purification may be carried out by a method in which the resin solution is poured into a solvent which does not dissolve the resin to precipitate the resin, a method in which the resin solution is dispersed in hot water, followed by evaporation of the solvent or a method in which the resin solution is subjected to absorption column chromatography.

The resin after purification may be precipitated in a solvent such as water, alcohol or another solvent which does not dissolve the resin or may be obtained according to a method in which the resin solution is mixed with hot water or a solvent which does not dissolve the resin, followed by removal of the solvent or a method in which the solvent is removed from the resin solution by heat application or under reduced pressure. When the resin obtained above is in the slurry form, the slurry is subjected to centrifuge or filtration to obtain a solid resin.

The thus obtained resin is ordinarily dried at a temperature not more than the decomposition temperature of the resin, and preferably dried under reduced pressure at a temperature of not less than 20° C. and not more than a melting temperature of the resin. The drying period is not shorter than a period dried so that impurities such as residual solvents in the resin are not more than a specific amount. Generally, the drying is carried out for not shorter than a period in which the residual solvent amount in the resin is not more than 1000 ppm, preferably not more than 300 ppm, and more preferably not more than 100 ppm.

The resin used in the invention having a repeating unit represented by formula (1) above has a viscosity average molecular weight of from 10,000 to 1,500,000, preferably from 15,000 to 100,000, and more preferably from 20,000 to 50,000. The resin having a viscosity average molecular weight of less than 10,000 is low in mechanical strength, which cannot be put into practical use, while the resin having a viscosity average molecular weight exceeding 1,500,000 is difficult to form a film with an appropriate thickness.

The resin used in the invention having a repealing unit represented by formula (1) above is mixed with other resins and used in an electrophotographic photoreceptor. Examples of other resins to be mixed include vinyl polymers such as polymethyl methacrylate, polystyrene and polyvinyl chloride, or copolymers thereof thermoplastic resins such as polycarbonate, polyester, polysulfone, a phenoxy resin, an epoxy resin and a silicone resin; and other various heat curable resins. Among these, a polycarbonate is preferred.

Next, an ultraviolet absorbent added to the charge transport layer constituting the electrophotographic photoreceptor of the invention will be explained. The ultraviolet absorbent added to the charge transport layer is preferably one which can absorb an irradiation light represented by ultraviolet light and emit a heat energy or a light energy at the level that does not have an influence on the charge transport material. Some of the ultraviolet absorbents absorb ultraviolet light and decompose. Such ultraviolet absorbents are undesired, since there is problem in that they generate trap sites in the photoreceptive layer and deteriorate electrical properties of the photoreceptor during repeated use.

The ultraviolet absorbent used in the invention is preferably one which has an absorption band in the wavelength region of from 315 to 400 nm called UV-A, more preferably one which has an absorption peak in the wavelength region of from 325 to 390 nm, and still more preferably one which has an absorption peak in the wavelength region of from 330 to 380 nm. In the invention, it has been found that a charge transport layer containing the ultraviolet absorbent having an absorption band in the wavelength region described above can provide high electric potential stability and prints without lowering image quality.

As the ultraviolet absorbents used in the invention, there are mentioned known ultraviolet absorbents such as a benzotriazole ultraviolet absorbent, a benzophenone ultraviolet absorbent, a triazine ultraviolet absorbent, a cyanoacrylate ultraviolet absorbent, a salycilate ultraviolet absorbent, a benzoate ultraviolet absorbent and a diphenylacrylate ultraviolet absorbent. Among these, a benzotriazole ultraviolet absorbent, a benzophenone ultraviolet absorbent and a triazine ultraviolet absorbent are preferred.

Examples of the ultraviolet absorbent usable for the invention will be listed below, but the invention is not specifically limited thereto.

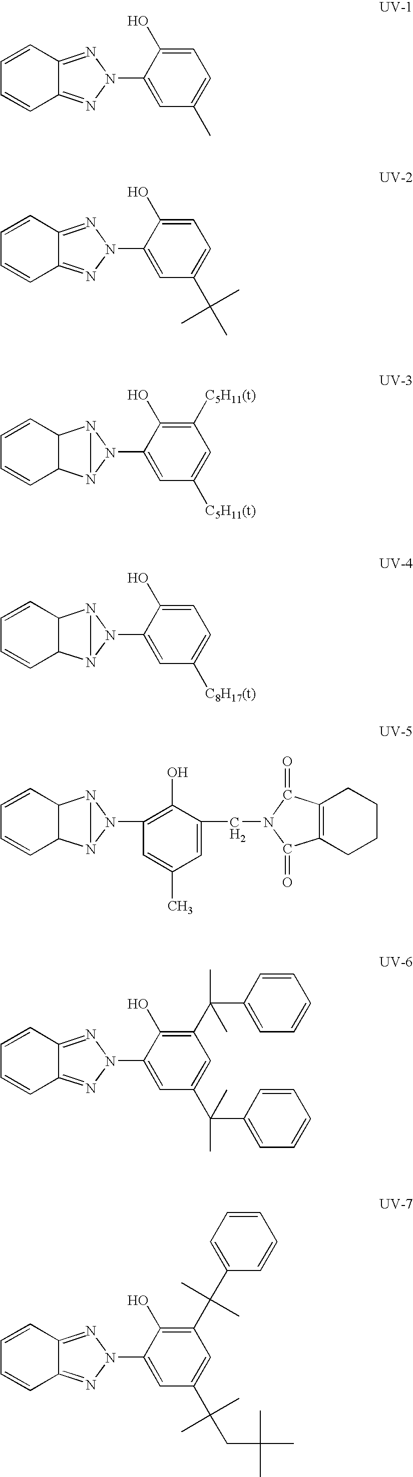

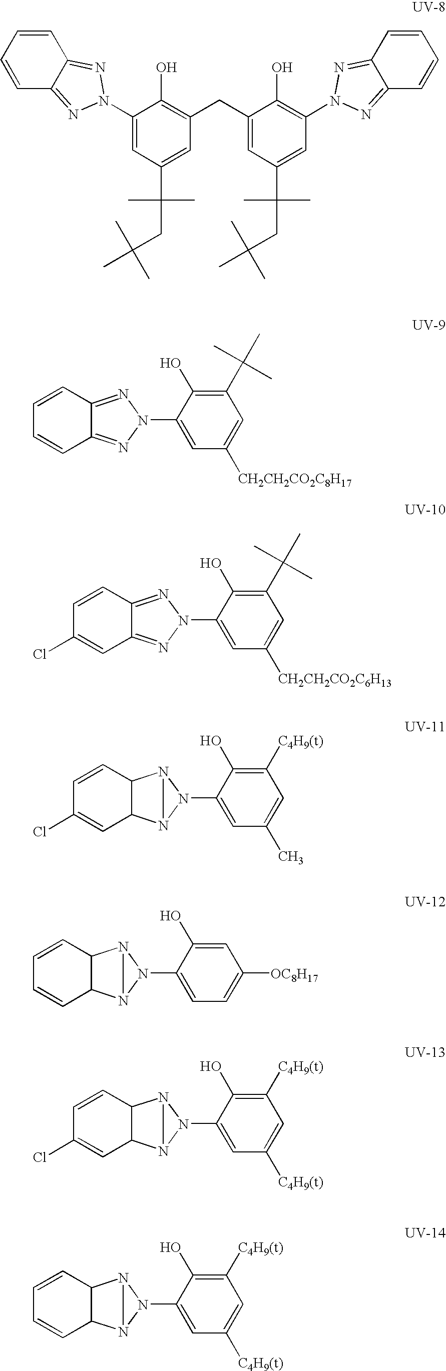

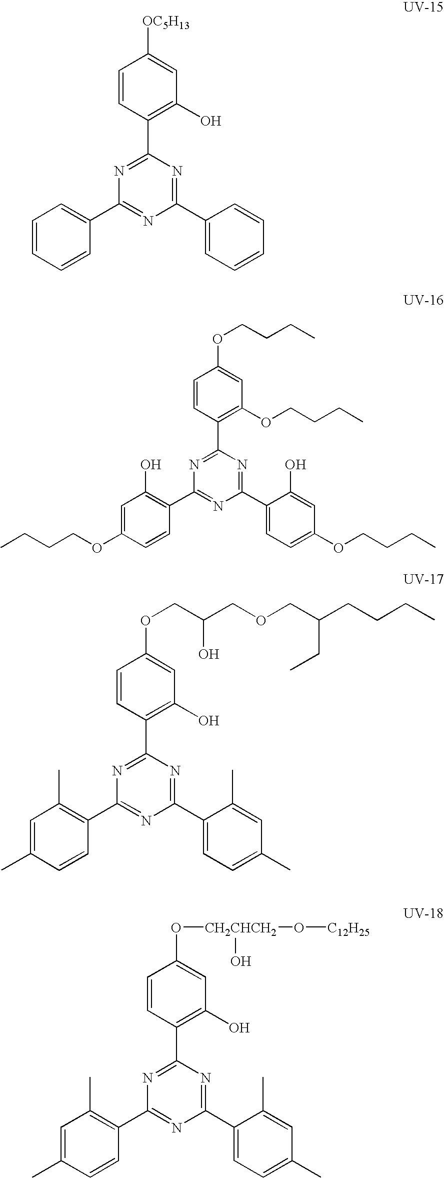

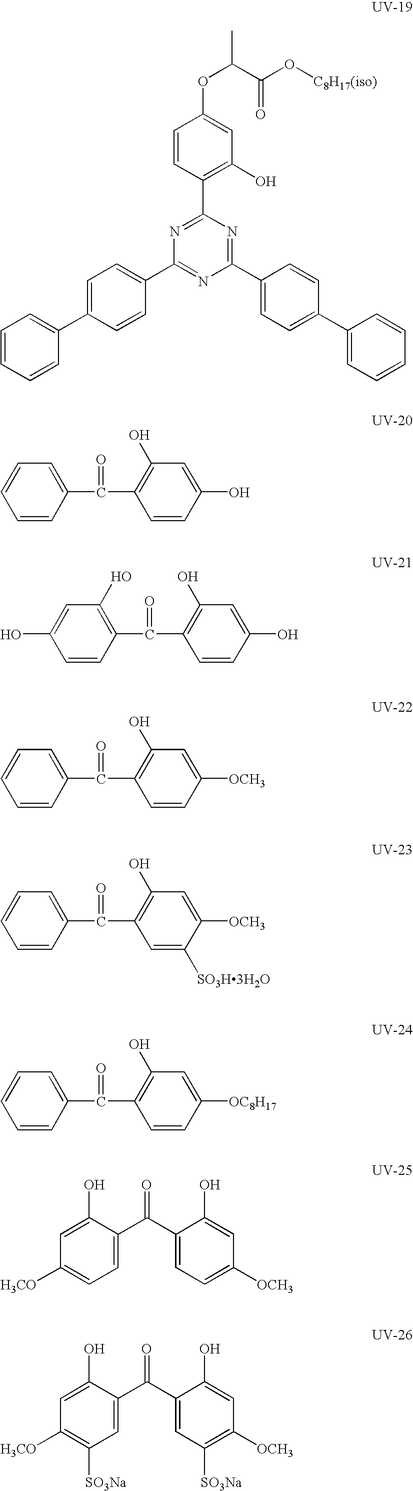

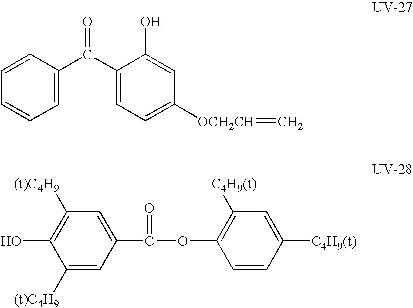

The ultraviolet absorbent used in the invention can be synthesized according to a method disclosed in Japanese Patent Publication No. 44-26920 or a method similar to the disclosed method. Products available on the market can be also used. As the products available on the market, there are mentioned a product of Ciba, Japan, Co., Ltd., a product of Kyodo Yakuhin Co., Ltd., and a product of Shipro Co., Ltd.

The ultraviolet absorbent used in the invention is preferably one having an absorption peak in the wavelength region of from 315 to 400 nm. The absorption peak herein referred to may be one of any shape which can be observed as a peak in the ultraviolet absorption spectra and need not be the largest peak, however, the absorption peak is preferably the largest peak. The ultraviolet absorbent having an absorption peak in the wavelength region of from 315 to 400 nm minimizes damage to the charge transport material represented by formula (2) due to ultraviolet light exposure, whereby deterioration of the charge transport material is restrained, improving electric potential stability during repeated use. The absorption peak of the ultraviolet absorbent can be determined employing a spectrophotometer available on the market capable of measuring the ultraviolet regions, for example, an ultraviolet and visible spectrophotometer “V-630” manufactured by Nippon Bunko Co., Ltd.

The content in the charge transport layer of the ultraviolet absorbent is from 0.1 to 30.0% by weight, and preferably from 3.0 to 15.0% by weight based on the weight of the charge transport material. The above content of the ultraviolet absorbent provides an electrophotographic photoreceptor with high stability in which when image formation is repeatedly carried out at high speed, exposure electric potential fluctuation is reduced and an image memory generation is prevented, thereby forming a stable image for a long period.

Next, the charge transport material used in the charge transport layer in the invention will be explained.

In the invention, a compound used as the charge transport material is represented by formula (2).

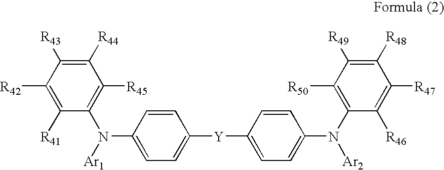

In formula above, R₄₁ through R₅₀ independently represent a hydrogen atom, an alkyl group, an aryl group or an alkoxy group; Ar₁ and Ar₂ independently represent an aromatic hydrocarbon group which may have a substituent; Y represents a divalent group represented by the formula (B).

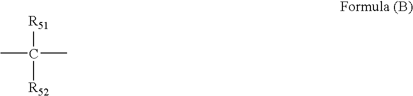

R₅₁ and R₅₂ independently represent a hydrogen atom, an alkyl group, a fluorinated alkyl group, an aryl group or an alkoxy group, or R₅₁ and R₅₂ combine with each other to form a cycloalkylidene group or a fluorenylidene group.

In R₄₁ through R₅₀ of formula (2) above, examples of the alkyl group include a methyl group, an ethyl group, a propyl group and a butyl group; and examples of the alkoxy group include a methoxy group, an ethoxy group, a propoxy group, and a butoxy group. Among these, a methyl group, an ethyl group, a propyl group and a methoxy group are preferred.

In Ar₁ and Ar₂ of formula (2) above, examples of the aromatic hydrocarbon group which may have a substituent include an aryl group, a biphenyl group, a naphthyl group, a fluorenyl group, a dibenzofuranyl group, and a dibenzothiophenyl group. Among these, an aryl group, a biphenyl group and a fluorenyl group are preferred. As the substituent which the aromatic hydrocarbon group may have, there is mentioned an alkyl group or an alkoxy group, wherein examples of the alkyl group include a methyl group, an ethyl group, a propyl group and a butyl group and examples of the alkoxy group include a methoxy group, an ethoxy group and a propoxy group. Among these, a methyl group and an ethyl group are preferred.

In R₅₁ and R₅₂ of formula (B) above, examples of the alkyl group include a methyl group, an ethyl group, a propyl group and a butyl group and an isopropyl group; examples of the fluorinated alkyl group include a trifluoromethyl group and a pentafluoroethyl group; examples of the alkoxy group include a methoxy group, an ethoxy group, a propoxy group and a butoxy group; examples of the aryl group include a phenyl group and a naphthyl group. Among these, a methyl group, an ethyl group, a propyl group and an isopropyl group are preferred.

In formula (B), as the cycloalkylidene group which R₅₁ and R₅₂ combine with each other to form, there is mentioned a cyclopentylidene group, a cyclohexylidene group or a cycloheptylidene group. Among these, a cyclohexylidene group is preferred.

The charge transport material described above exhibits less absorption to an exposure source emitting light with a wavelength of from 380 to 500 nm, and increases an electric potential attenuation value to unit exposure amount, whereby the repeated properties are improved, and a small size dot image can be sharply formed. Further, when the charge transport material is used together with the resin having a repeating unit represented by formula (1), its compatibility with the binder is improved, whereby crack resistance of the formed charge transport layer is improved.

Typical examples of the charge transport material used in the invention will be listed below, but the charge transport material usable for the invention is not limited thereto.

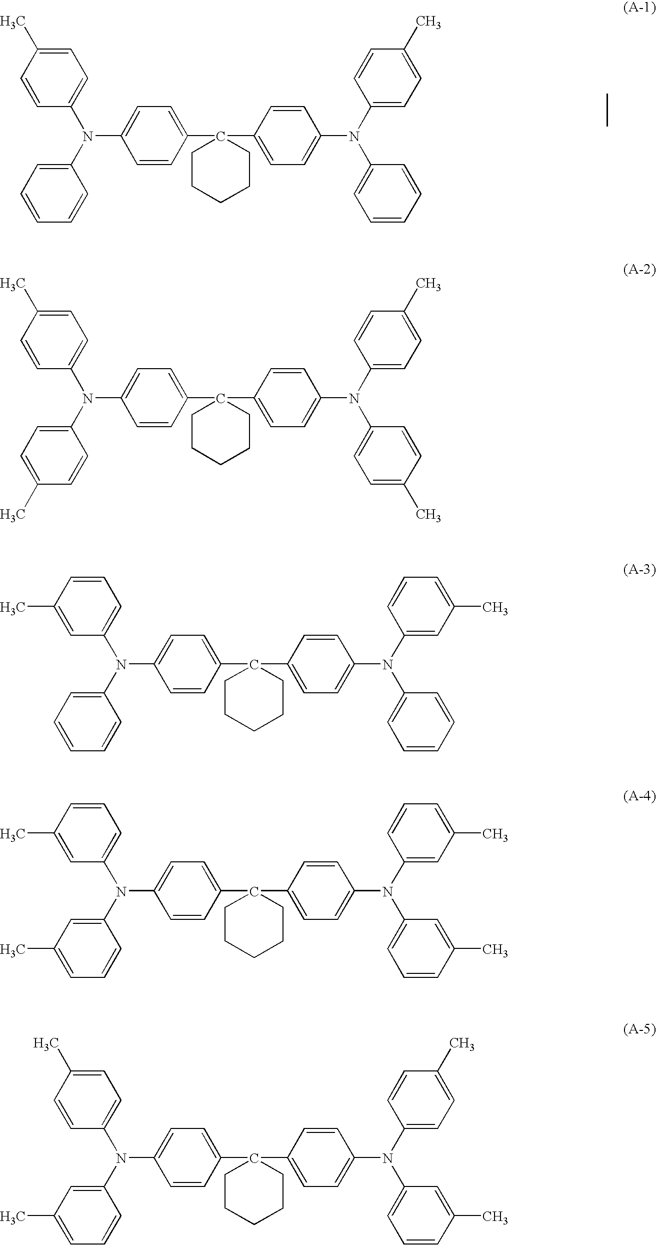

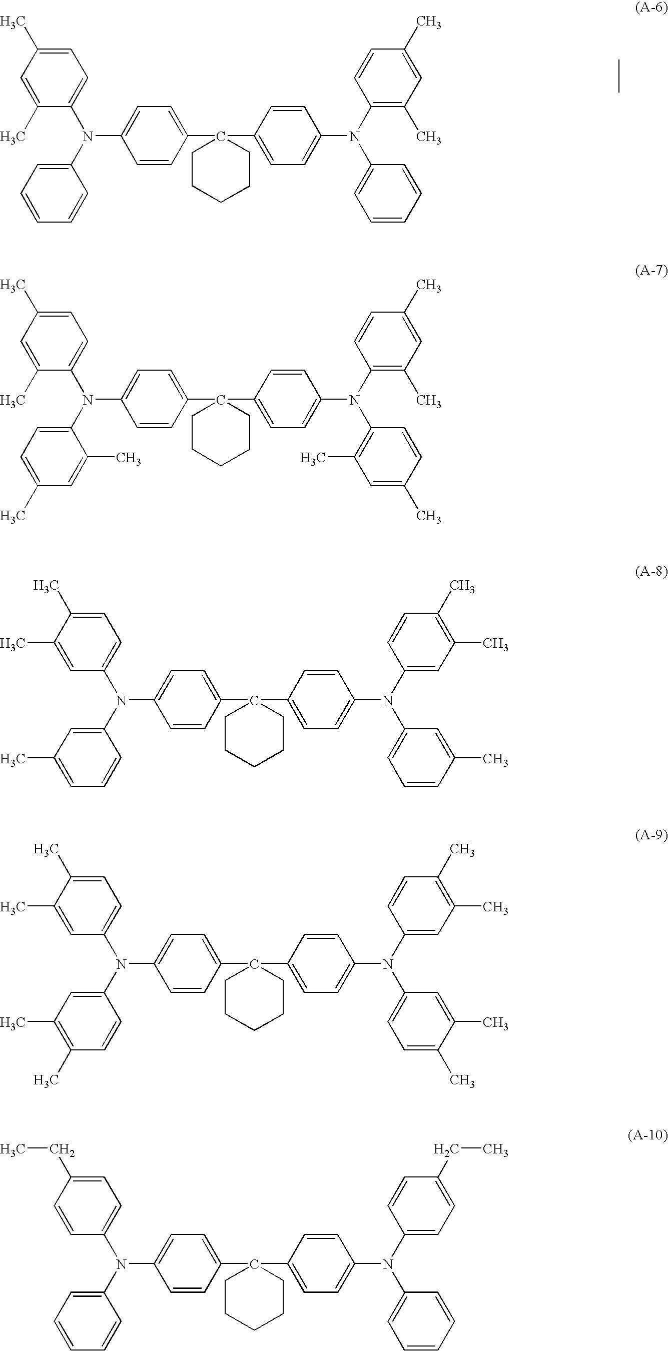

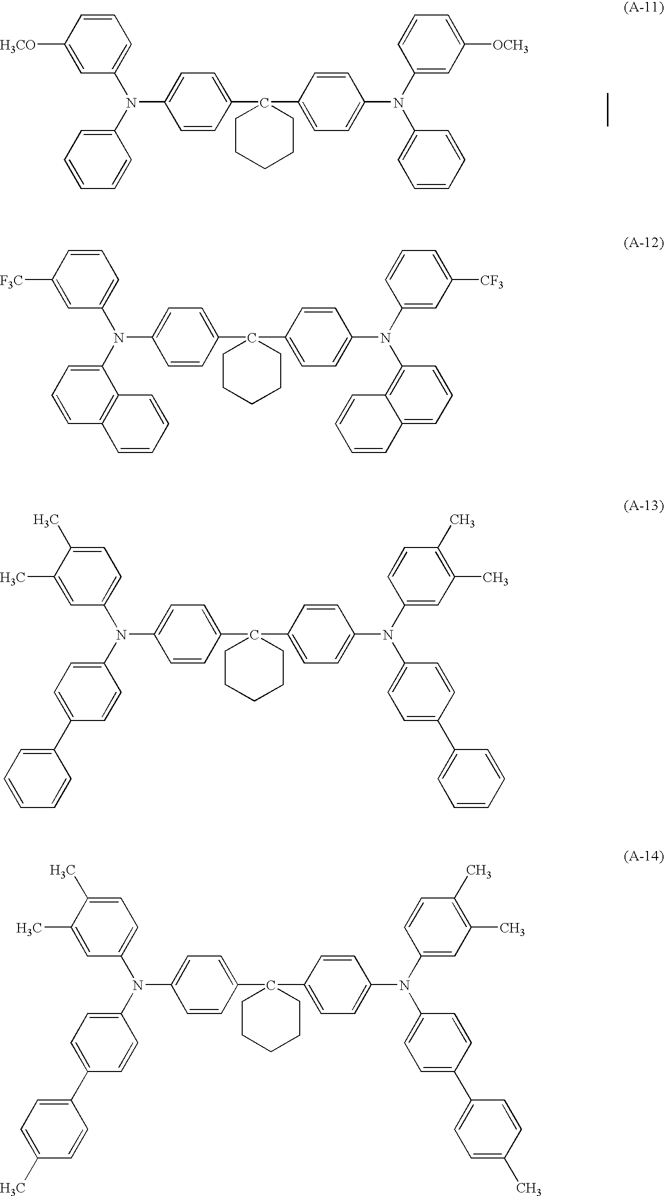

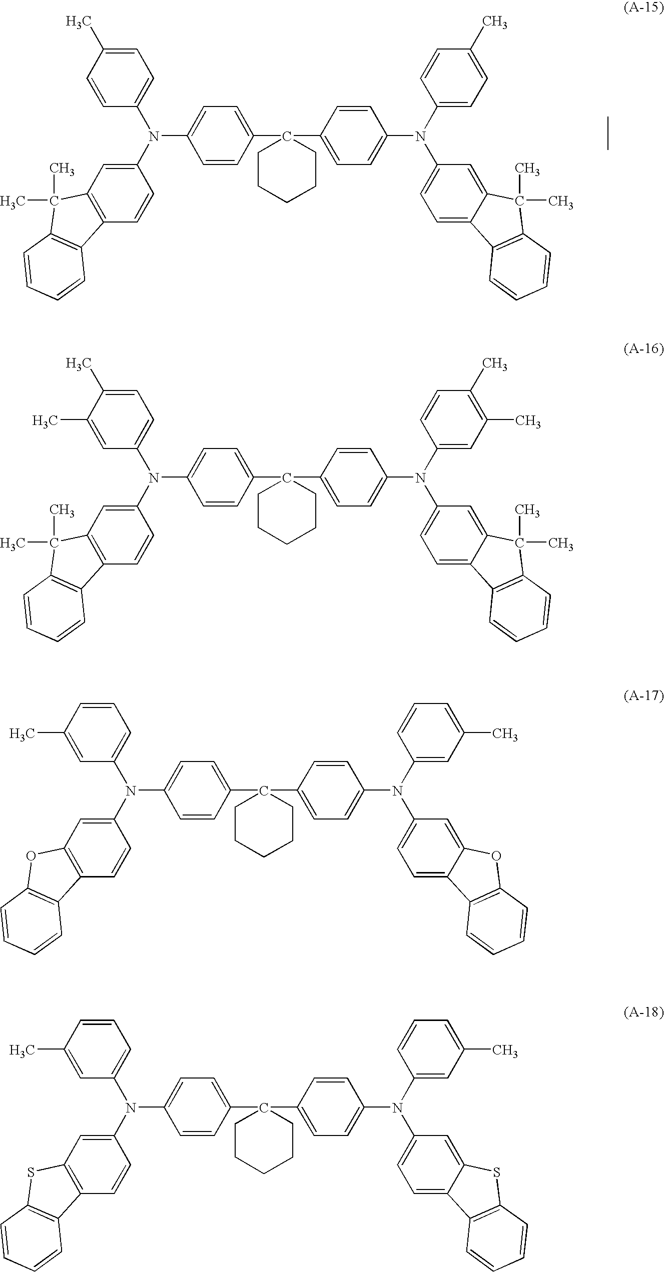

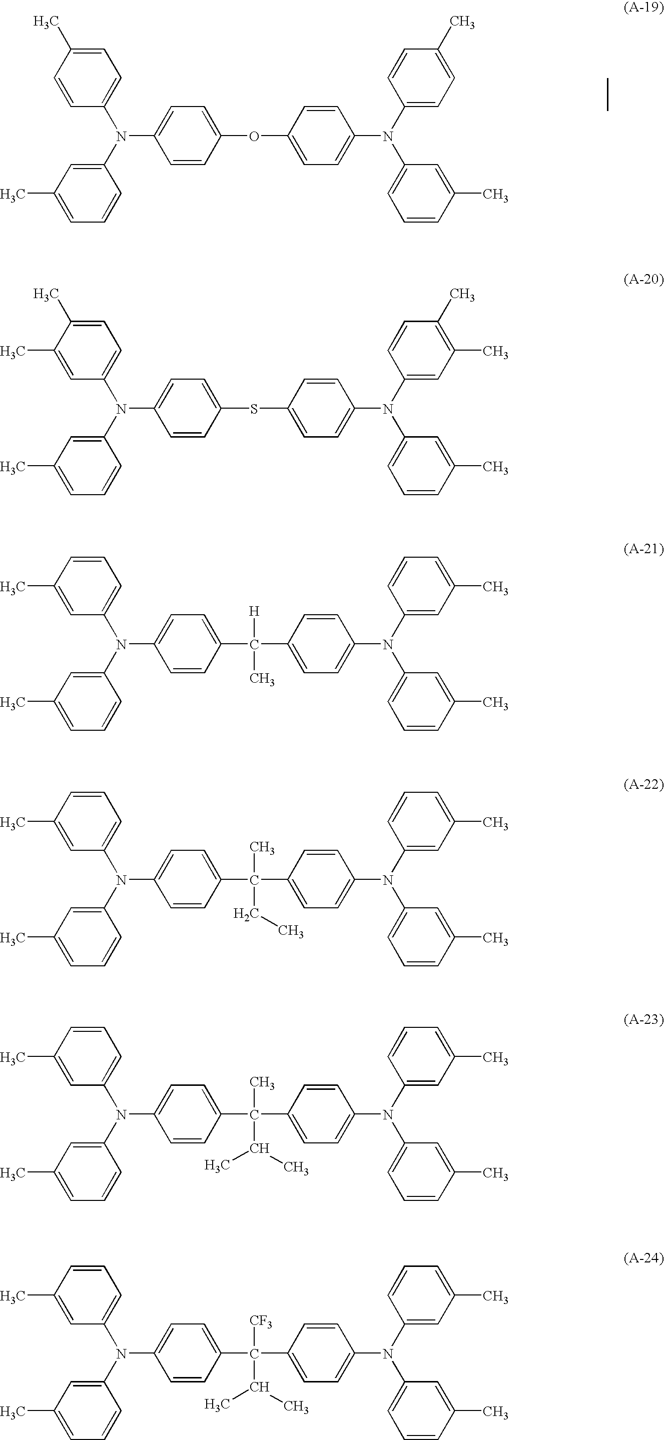

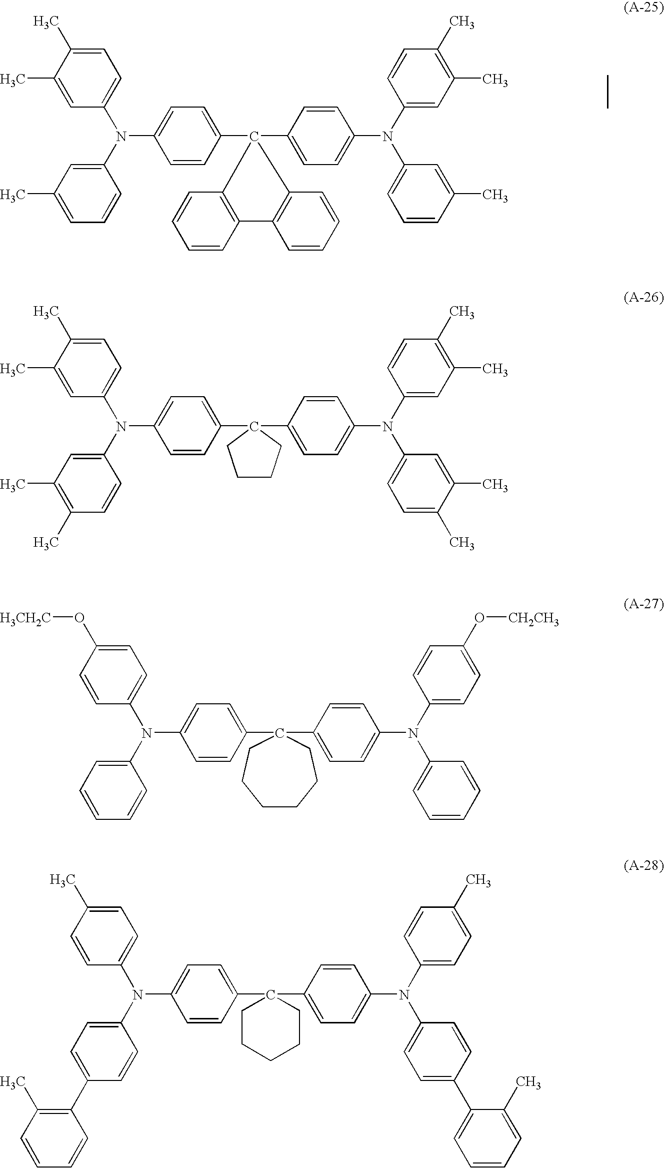

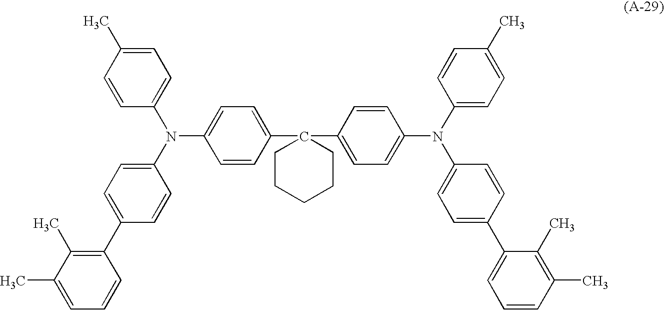

Among these, Exemplified compounds (A-13) through (A-18), (A-28) and (A-29), each having a biphenyl structure, are preferred as the charge transport material in the charge transport layer in the invention, and Exemplified compounds (A-28) and (A-29) having an alkyl group at an ortho position of the biphenyl structure have high compatibility with the binder resin and are especially preferred.

The constitution of the electrophotographic photoreceptor of the invention is not specifically limited, as long as the photoreceptor comprises the charge transport material described above represented by formula (2) and the resin described above having a repeated unit represented by formula (1). For example, the following constitutions are mentioned.

1) A constitution that a photoreceptor comprises an electrically conductive support and provided thereon, a charge generation layer and a charge transport layer in that order, each layer being a photoreceptive layer

2) A constitution that a photoreceptor comprises an electrically conductive support and provided thereon, a charge generation layer, a first charge transport layer and a second charge transport layer in that order, each layer being a photoreceptive layer

3) A constitution that a surface protective layer is further provided on the photoreceptive layer of the photoreceptor mentioned in items 1) and 2) above

The photoreceptor may have any one of the constitutions above. The electrophotographic photoreceptor of the invention may have any constitutions or a constitution that a subbing layer (an intermediate layer) is provided between a photoreceptive layer and an electrically conductive support.

The charge transport layer in the invention refers to a layer having a function of transporting to the surface of the organic photoreceptor a charge carrier generated in the charge generation layer on light exposure. The charge transport function can be confirmed by detecting the photoconductivity of the charge generation layer and the charge transport layer provided on an electrically conductive support.

Next, the layer constitution of an electrophotographic photoreceptor will be explained, mainly based on the constitution of item 1) above.

### Electrically Conductive Support

As the electrically conductive support, the support may be in the sheet form or in the cylindrical form, but is preferably an electrically conductive support in the cylindrical form, in designing a compact image formation apparatus.

The electrically conductive support in the cylindrical form refers to a cylindrical support necessary to endlessly form an image by rotation, and it is preferably an electrically conductive support having a straightness of not more than 0.1 mm and a deflection of not more than 0.1 mm. If the straightness or the deflection falls outside the above ranges, it is difficult to form an excellent image.

As electrically conductive materials, there are mentioned a drum of a metal such as aluminum or nickel; a plastic drum onto which aluminum, tin oxide or indium oxide is evaporation deposited; and a paper or plastic drum which is coated with an electrically conductive substance. The electrically conductive support is preferably one having a specific resistance of not more than 10³ Ω·cm. The electrically conductive support in the invention is most preferably an aluminum support. As the aluminum support, there can be employed a support containing manganese, zinc or magnesium in addition to aluminum as a main component.

### Intermediate Layer

In the invention, it is preferred that an intermediate layer is provided between the photoreceptive layer and the electrically conductive support.

It is preferred that the intermediate layer contains N-type semiconductive particles. The N-type semiconductive particles refer to particles in which the main charge carrier is an electron. That is, an intermediate layer containing the N-type semiconductive particles dispersed in an insulating binder has a property which effectively blocks hole injection from the support and less blocks electron injection from the photoreceptive layer, since the main charge carrier in the particles is an electron.

As a binder resin dispersing the particles and constituting the intermediate layer, a polyamide resin is preferred in obtaining good particle dispersibility. Particularly, polyamide resins as described below are preferred.

As the polyamide resin used as the binder resin of the intermediate layer, a polyamide resin soluble in alcohol is especially preferred.

### Photoreceptive Layer

The photoreceptive layer constitution of the electrophotographic photoreceptor of the invention is a constitution such that the function of the photoreceptive layer is divided into two, function of a charge generation layer (CGL) and function of a charge transport layer (CTL). The constitution in which the function is divided into the above two makes it possible to minimize residual electric potential increase due to repeated use and to easily control other electrophotographic properties in accordance with an intended object.

Next, constitution of the photoreceptive layer of the function separation negatively charging photoreceptor will be explained.

### Charge Generation Layer

As a charge generation material used in the charge generation layer in the electrophotographic photoreceptor of the invention, a compound is properly selected, based on the wavelength of exposure light. In order to obtain an image with high precision, a charge generation material having high sensitivity to the wavelength region of from 380 to 500 nm is preferably used as the charge generation material. As such a charge generation material, there can be used an azo pigment, a perylene pigment or a polycyclic quinone pigment.

Particularly, polycyclic quinone pigments such as dibromoanthanthrone and the like, which have high sensitivity to a short wavelength laser available on the market having an emission wavelength of around 405 nm, are preferably used. Typical examples thereof will be listed below.

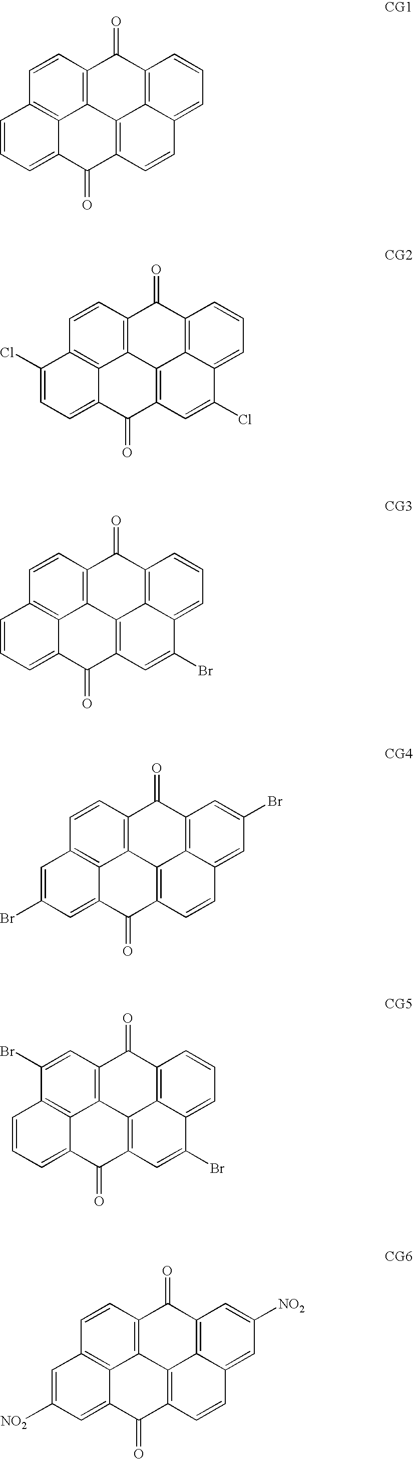

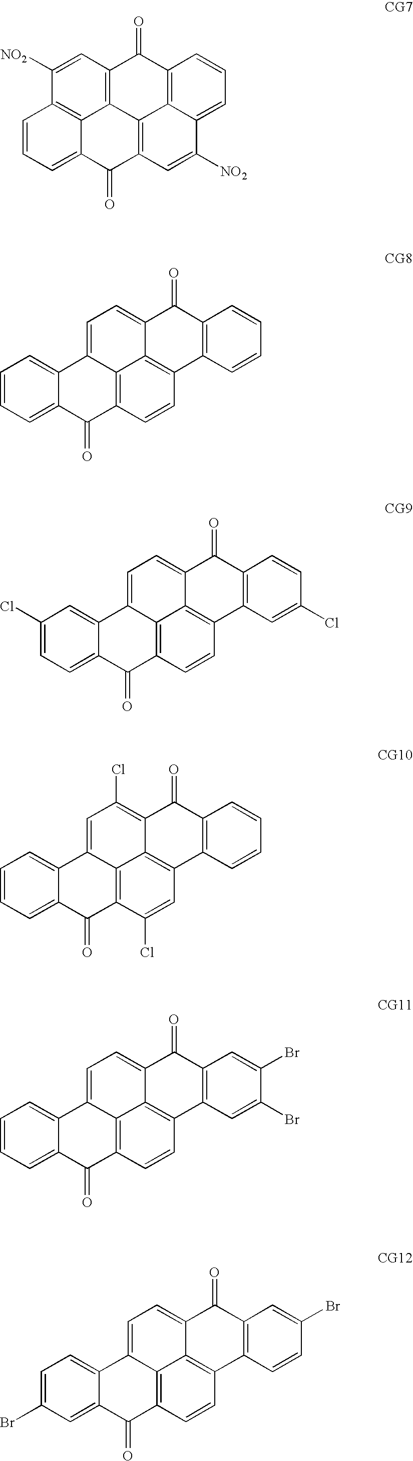

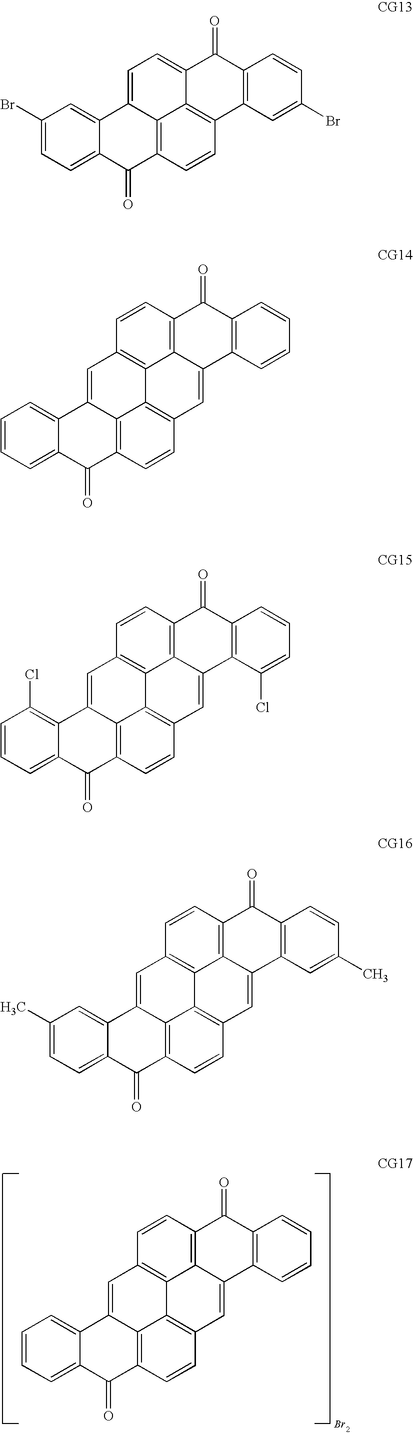

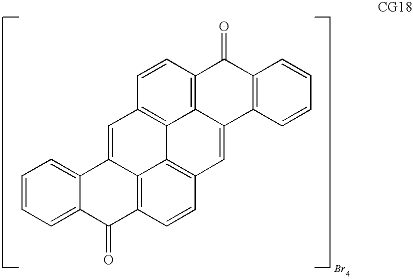

These pigments can be used in combination.

When a binder is used as a dispersion medium for CGM in the charge generation layer, a known resin is used as the binder. As the preferred resins, there can be mentioned a formal resin, a butyral resin, a silicone resin, a silicone-modified butyral resin and a phenoxy resin. The content of the charge generation material in the charge generation layer is preferably from 20 to 800 parts by weight based on 100 parts by weight of resin as the binder. The above resin in the charge generation layer most effectively minimizes the residual potential increase during repeated use. The thickness of the charge generation layer is preferably from 0.3 to 2 μm.

### Charge Transport Layer

In the invention, it is possible to add optionally inorganic particles such as silica or alumina particles, organic particles such as fluorine-containing resin particles, and additives such as an antioxidant and a plasticizer to the charge transport layer, besides the charge transport material (CTM) or the resin each described above.

As the charge transport material (CTM), the charge transport material represented by formula (2) above is used, but known hole transport (P type) charge transport material (CTM) can be used in combination with the charge transport material represented by formula (2).

As the binder resin used in the charge transport layer (CTL), the resin having a repeated unit represented by formula (1) above is used, but in addition to this resin, a known thermoplastic resin or a heat curable resin can be used in combination. As resins used in combination with the resin having a repeated unit represented by formula (1) above, there are mentioned a polystyrene, an acryl resin, a methacryl resin, a vinyl acetate resin, a polyvinyl butyral resin, an epoxy resin, a polyurethane resin, a phenol resin, a polyester resin, an alkyd resin, a silicone resin and a melamine resin. Copolymers having in the molecule at least two of the repeated unit contained in these resins can be used Further, polymer organic semiconductors such as polyvinyl carbazole and the like other than these insulating resins can be used in combination.

The content of the charge transport material in the charge transport layer is preferably from 50 to 200 parts by weight based on 100 parts by weight of binder resin. The above resin in the charge generation layer most effectively minimizes the residual electric potential increase during repeated use. The thickness of the charge generation layer is preferably from 0.3 to 2 μm.

The thickness of the charge transport layer is preferably from 10 to 30 μm. The charge transport layer thickness, when it is from 10 to 30 μm, does not prevent obtaining a latent image electric potential during development or an intended image density. Further, the aforementioned thickness does not cause diffusion of charge carrier (diffusion of charge carrier generated in the charge generation layer), nor does it have an influence on dot reproduction.

The charge transport layer in the electrophotographic photoreceptor of the invention can contain an anti-oxidant The charge transport layer has problem in that it is oxidized by action of active gases such as nitrogen oxides or ozone generated during charging, resulting in image blurring due to oxidation. The presence of the anti-oxidant prevents oxidation of the surface layer of the electrophotographic photoreceptor, and occurrence of the image blurring.

As the anti-oxidants, there are mentioned known ones described later. Examples thereof include a phenol anti-oxidant (a hindered phenol), an amine anti-oxidant (a hindered amine, a diaryldiamine, a diarylamine), a hydroquinone anti-oxidant, a sulfur containing anti-oxidant (a thioether), and a phosphoric acid anti-oxidant (a phosphorous acid ester). Among these, particularly a hindered phenol anti-oxidant or a hindered amine anti-oxidant is effective in preventing occurrence of fog under high temperature and high humidity or of image blurring.

As solvents or dispersion media used for forming a layer such as the intermediate layer, charge generation layer or charge transport layer, there are mentioned known ones described later. Examples thereof include n-butylamine, diethylamine, ethylene diamine, isopropanolamine, triethanolamine, Methylene diamine, N,N-dimethylformamide, acetone, methyl ethyl ketone, methyl isopropyl ketone, cyclohexanone, benzene, toluene, xylene, chloroform, dichloromethane, 1,2-dichloroethane, 1,2-dichloropropane, 1,1,2-trichloroethane, 1,1,1-trichloroethane, trichloroethylene, tetrachloroethane, tetrahydrofuran, dioxolane, dioxane, methanol, ethanol, butanol, isopropanol, ethyl acetate, butyl acetate, dimethylsulfoxide, and methyl cellosolve. The present invention is not limited to these, but dichloromethane, 1,2-dichloroethane or methyl ethyl ketone is preferably used. These solvents may be used singly or as an admixture of two or more kinds thereof.

As a coating method used to manufacture the electrophotographic photoreceptor of the invention, there are mentioned known methods. Examples thereof include a coating method employing a circular slide hopper type coating apparatus, an immersion coating method and a spray coating method.

Next, an image formation apparatus employing the photoreceptor of the invention will be explained.

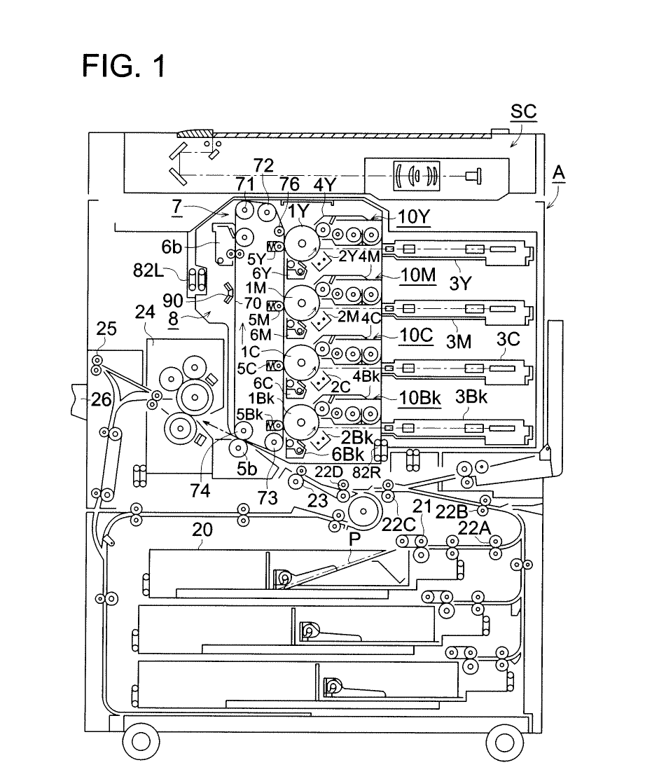

FIG. 1 is a sectional view of a color image formation apparatus capable showing one embodiment of the invention.

This image formation apparatus is called a tandem color image formation apparatus, which is composed of four image formation sections (image formation units) 10Y, 10M, 10C and 10Bk, an endless belt intermediate transfer member unit 7, a paper feeding and conveying member 21, and a fixing device 24. A reading device SC for reading an original is disposed in the upper portion of the image formation apparatus body A.

Image formation section 10Y to form a yellow image comprises a drum-shaped photoreceptor 1Y as a first image carrying member, and disposed at the circumference of the photoreceptor 1Y, a charging device (charging step) 2Y, an exposing device (exposing step) 3Y, a developing device (developing step) 4Y, a primary transfer roller 5Y as a primary transfer device (primary transfer step) and a cleaning device (cleaning step) 6Y. Image formation section 10M to form a magenta image comprises a drum-shaped photoreceptor 1M as a first image carrying member, a charging device 2M, an exposing device 3M, a developing device 4M, a primary transfer roller 5M as a primary transfer device and a cleaning device 6M. Image formation section 10C to form a magenta image comprises a drum-shaped photoreceptor 1C as a first image carrying member, a charging device 2C, an exposing device 3C, a developing device 4C, a primary transfer roller 5C as a primary transfer device and a cleaning device 6C. Image formation section 10Bk to form a black image comprises a drum-shaped photoreceptor 1Bk as a first image carrying member, a charging device 2Bk, an exposing device 3Bk, a developing device 4Bk, a primary transfer roller 5Bk as a primary transfer device and a cleaning device 6Bk.

The aforementioned four image formation sections 10Y, 10M, 10C and 10Bk respectively comprises photoreceptor drums 1Y, 1M, 1C and 1Bk, and disposed at the circumference of the photoreceptor drums, rotary charging devices 2Y, 2M, 2C and 2Bk, exposing devices 3Y, 3M, 3C and 3Bk, rotary developing devices 4Y, 4M, 4C and 4Bk, and cleaning devices 5Y, 5M, 5C and 5Bk for cleaning the photoreceptor drums 1Y, 1M, 1C and 1Bk.

The image formation sections 10Y, 10M, 10C and 10Bk have the same structure, except that colors of toner images formed on the respective photoreceptor drums 1Y, 1M, 1C and 1Bk are different. Next, explanation will be made in detail employing the image formation unit 10Y as an example.

The image formation unit 10Y comprises a photoreceptor drum 1Y, which is an image formation member, and disposed at the circumference of the photoreceptor drum, a charging device 2Y (hereinafter also referred to simply as charging device 2Y or charger 2Y), an exposing device 3Y, a developing device 4Y, and a cleaning device 5Y (hereinafter also referred to simply as cleaning device 5Y or cleaning blade 5Y), and forms a yellow toner image on the photoreceptor drum 1Y.

In the embodiment of the invention, at least the photoreceptor drum 1Y, the exposing device 2Y, the developing device 4Y and the cleaning device 5Y in the image formation unit 10Y are integrated.

The charging device 2Y is one providing a uniform electric potential on the photoreceptor drum 1Y. In the embodiment of the invention, a corona discharge type charger 2Y are used for the photoreceptor drum 1Y.

The exposing device 3Y is one which exposes the photoreceptor drum 1Y given a uniform electric potential by the charger 2Y based on image signal (yellow) to form a latent image corresponding to a yellow image. As the exposing device 3Y, there is a device constituted of an imaging element and a light-emitting diode in which light-emitting elements are arranged in an array configuration in the axial direction of photoreceptor drum 1Y or a semiconductor laser optical system.

An endless belt intermediate transfer member unit 7, which is turned by plural rollers, comprises an endless belt intermediate transfer member 70 as a second image carrying member in the endless belt form, which is pivotably supported.

The individual color images formed by the image formation units 10Y, 10M, 10C and 10Bk are successively transferred onto the rotating endless belt intermediate transfer member 70 by primary transfer devices, primary transfer rollers 5Y, 5M, 5C and 5Bk, respectively, to form a composite color image. A transfer material P as a transfer material (a support with a final fixed image such as a plain paper sheet or a transparent sheet) housed in a paper feed cassette 20 is fed by a paper feed and conveyance device 21 and conveyed to a secondary transfer device, a secondary transfer roller 5b through plural intermediate rollers 22A, 22B, 22C and 22D and a resist roller 23, where color images are transferred together on the transfer material P. The transfer material P with the transferred color images is fixed by a fixing device 24, nipped by a paper discharge roller 25, and put onto a paper discharge tray 26 outside a machine. Herein, a transfer support such as the intermediate transfer member and the transfer material, onto which toner images formed on a photoreceptor are transferred, is collectively referred to as a transfer medium.

After a color image is transferred onto the transfer material P by a secondary transfer roller 5b as a secondary transfer device, any residual toner which remains on the endless belt intermediate transfer member 70 from which the transfer material P is separated is removed by a cleaning device 6b.

During image formation, the primary transfer roller 5Bk is always in contact with the photoreceptor 1Bk. Other primary rollers 5Y, 5M and 5C are brought into contact with the photoreceptors 1Y, 1M and 1C, respectively, only at the time when color images are formed on the photoreceptors 1Y, 1M and 1C.

The secondary transfer roller 5b is brought into contact with the endless belt intermediate transfer member 70 only when secondary transfer onto the transfer material P is carried out.

The housing 8 is disposed in the image formation apparatus body A so that it can be pulled out from the image formation apparatus body A through supporting rails 82L and 82R.

The housing 8 is composed of image formation sections 10Y, 10M, 10C and 10Bk, and an endless belt intermediate transfer material unit 7.

Image formation sections 10Y, 10M, 10C, and 10Bk are arranged in column in the vertical direction. The endless belt intermediate transfer unit 7 is disposed on the left side in the FIGURE of the photoreceptor drums 1Y, 1M, 1C, and 1Bk. The endless belt intermediate transfer unit 7 is composed of an endless belt intermediate transfer member 70 capable of rotating, which can rotate rollers 71, 72, 73 and 74, primary image transfer rollers 5Y, 5M, 5C, and 5131c, as well as the cleaning device 6b.

The image formation apparatus of the present invention can be applied in general to electrophotographic apparatuses such as electrophotographic copiers, laser printers, LED printers, as well as liquid crystal shutter type printers, and in addition, it can be widely applied to apparatuses applying electrophotographic technology such as a display, a recorder, a light printing system, a plate-making system, and a facsimile equipment.

Next, the present invention will be explained in detail, employing examples and comparative examples, but the invention is not limited thereto. In the examples, “parts” represents “parts by weight”.

### (Preparation of Photoreceptor 1)

A photoreceptor 1 having the constitution of the invention was prepared according to the following procedures.

The surface of a cylindrical aluminum support was subjected to cutting process, whereby an electrically conductive support with a 10 point surface roughness (Rz JIS=1.5 μm) was prepared.

### <Formation of Intermediate Layer>

| | |
|---|---|
| Polyamide resin CM8000 (produced by Toray Industries, Inc.) | 10 parts |
| Inorganic particles: titanium oxide (with a number | 30 parts |
| average primary particle size of 35 nm, surface | |
| treated titanium oxide subjected to silica, | |
| alumina and methyl hydrogen polysiloxane treatment) | |
| Methanol | 80 parts |
| Butanol | 20 parts |

The above composition was mixed and dispersed in a sand mill as a homogenizer for 10 hours in a batch mode to obtain an intermediate layer dispersion. The resulting intermediate layer dispersion was diluted by two times with the same solvent (methanol), allowed to stand for 24 hours, and filtered (filter: a ridimesh filter having a filtering precision of 5 μm, manufactured by Nippon Pall Corp.) to obtain an intermediate layer coating solution.

The intermediate layer coating solution was coated on the electrically conductive support obtained above to form an intermediate layer having a dry thickness of 1.0 μm.

### <Formation of Charge Generation Layer>

| | |
|---|---|
| Charge generation material (CGM): Y-type titanyl | 24 parts |
| phthalocyanine (titanyl phthalocyanine pigment having a | |
| maximum diffraction peak at least at a position of 27.3° | |
| in the Cu-Ka characteristic X-ray diffraction spectra) | |
| Polyvinyl butyral resin Eslek BL-1 (manufactured by | 12 parts |
| Sekisui Chemical Co., Ltd.) | |
| 2-Butanone/cyclohexanone (4/1 by volume) | 300 parts |

The above composition was mixed and dispersed in a sand mill to obtain a charge generation layer coating solution. This solution was coated on the intermediate layer by means of an immersion coating method to form a charge generation layer having a dry thickness of 0.5 μm.

### <Formation of Charge Transport Layer>

| | | |
|---|---|---|
| Binder resin: Exemplified compound 1-1 (with a | 300 | parts |
| viscosity average molecular weight of about 30,000) | | |
| Charge transport material: Exemplified compound A-8 | 225 | parts |
| Ultraviolet absorbent: Exemplified compound UV-1 | 12 | parts |
| Tetrahydrofuran | 1600 | parts |
| Toluene | 400 | parts |
| Anti-oxidant (Irganox 1010, manufactured by Ciba | 20 | parts |
| Japan K.K.) | | |
| Silicone oil (KF-50, manufactured by Shin-Etsu Chemical | 0.2 | parts |
| Co., Ltd.) | | |

The above composition was mixed to obtain a charge transport layer coating solution. This solution was coated on the charge generation layer by means of an immersion coating method, and dried at 110° C. for 70 minutes to form a charge transport layer having a dry thickness of 20.0 p.m. Thus, a photoreceptor 1 was prepared. In the photoreceptor 1, the content of the ultraviolet absorbent was 5.3% by weight based on the weight of the charge transport material.

### (Preparation of Photoreceptor 2)

The same procedure as the photoreceptor 1 above was carried out till the intermediate layer was formed.

### <Formation of Charge Generation Layer>

| | |
|---|---|
| Charge generation material: Exemplified compound CG 12 | 24 parts |
| Polyvinyl butyral resin Eslek BL-S (manufactured by Sekisui | 6 parts |
| Chemical Co., Ltd) | |
| 2-Butanone/cyclohexanone (4/1 by volume) | 300 parts |

The above composition was mixed and dispersed in a sand mill to obtain a charge generation layer coating solution. This solution was coated on the intermediate layer by means of an immersion coating method to form a charge generation layer having a dry thickness of 0.5 μm.

Successively, a charge transport layer was formed on the resulting charge generation layer in the same manner as in photoreceptor 1. Thus, a photoreceptor 2 was prepared. In the photoreceptor 2, the content of the ultraviolet absorbent was 5.3% by weight based on the weight of the charge transport material.

### (Preparation of Photoreceptor 3)

Photoreceptor 3 was prepared in the same manner as in photoreceptor 2 above, except that the charge generation material was changed to Exemplified compound CG 18. In the photoreceptor 3, the content of the ultraviolet absorbent was 5.3% by weight based on the weight of the charge transport material.

### (Preparation of Photoreceptor 4)

Photoreceptor 4 was prepared in the same manner as in photoreceptor 3 above, except that the binder resin in the charge transport layer was changed to Exemplified compound 1-2. In the photoreceptor 4, the content of the ultraviolet absorbent was 5.3% by weight based on the weight of the charge transport material.

### (Preparation of Photoreceptor 5)

Photoreceptor 5 was prepared in the same manner as in photoreceptor 4 above, except that the charge transport material was changed to Exemplified compound A-29. In the photoreceptor 5, the content of the ultraviolet absorbent was 5.3% by weight based on the weight of the charge transport material.

### (Preparation of Photoreceptors 6 Through 8)

Photoreceptors 6 through 8 were prepared in the same manner as in photoreceptor 5 above, except that the binder resin was changed to Exemplified compounds 1-10, 1-12, and 1-15, respectively. In the photoreceptors 6 through 8, the content of the ultraviolet absorbent was 5.3% by weight based on the weight of the charge transport material.

(Preparation of Photoreceptors 9 through 11)

Photoreceptors 9 through 11 were prepared in the same manner as in photoreceptor 5 above, except that the charge transport material was changed to Exemplified compounds A-13, A-15, and A-28, respectively, and the ultraviolet absorbent content was changed to 25 parts. In the photoreceptors 9 through 11, the content of the ultraviolet absorbent was 11.1% by weight based on the weight of the charge transport material.

### (Preparation of Photoreceptors 12 Through 14)

Photoreceptors 12 through 14 were prepared in the same manner as in photoreceptor 5 above, except that the ultraviolet absorbent was changed to UV-2, UV-15, and UV-17, respectively, and the ultraviolet absorbent content was changed to 25 parts. In the photoreceptors 12 through 14, the content of the ultraviolet absorbent was 11.1% by weight based on the weight of the charge transport material.

### (Preparation of Photoreceptor 15)

Photoreceptor 15 was prepared in the same manner as in photoreceptor 2, except that the ultraviolet absorbent content was changed to 0.23 parts. In the photoreceptor 15, the content of the ultraviolet absorbent was 0.1% by weight based on the weight of the charge transport material.

### (Preparation of Photoreceptor 16)

Photoreceptor 16 was prepared in the same manner as in photoreceptor 2, except that the ultraviolet absorbent content was changed to 67 parts. In the photoreceptor 16, the content of the ultraviolet absorbent was 29.8% by weight based on the weight of the charge transport material.

### (Preparation of Photoreceptor 17)

Photoreceptor 17 was prepared in the same manner as in photoreceptor 2, except that the ultraviolet absorbent content was changed to 6.8 parts. In the photoreceptor 17, the content of the ultraviolet absorbent was 3.0% by weight based on the weight of the charge transport material.

### (Preparation of Photoreceptor 18)

Photoreceptor 18 was prepared in the same manner as in photoreceptor 2, except that the ultraviolet absorbent content was changed to 33.8 parts. In the photoreceptor 18, the content of the ultraviolet absorbent was 15.0% by weight based on the weight of the charge transport material.

### (Preparation of Comparative Photoreceptor 1)

Comparative photoreceptor 1 was prepared in the same manner as in photoreceptor 2, except that the binder resin in the charge transport layer was changed to PC-1 described later. In the comparative photoreceptor 1, the content of the ultraviolet absorbent was 5.3% by weight based on the weight of the charge transport material.

PC-1: Resin having a repeated unit represented by the following chemical structure, and having a viscosity average molecular weight is about 32,000

In the structure, m is 70, and n is 30.

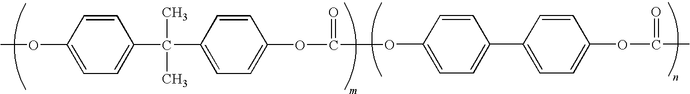

### (Preparation of Comparative Photoreceptor 2)

Comparative photoreceptor 2 was prepared in the same manner as in photoreceptor 2, except that the charge transport material was changed to CTM-A described later. In the comparative photoreceptor 2, the content of the ultraviolet absorbent was 5.3% by weight based on the weight of the charge transport material.

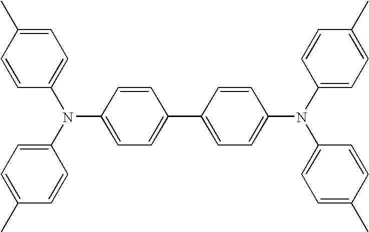

### (Preparation of Comparative Photoreceptor 3)

Comparative photoreceptor 3 was prepared in the same manner as in photoreceptor 2, except that the ultraviolet absorbent was not incorporated in the charge transport layer. Herein, the comparative photoreceptor 3 did not contain an ultraviolet absorbent

### (Preparation of Comparative Photoreceptor 4)

Comparative Photoreceptor 4 was prepared in the same manner as in photoreceptor 2, except that the ultraviolet absorbent content was changed to 0.07 parts. In the comparative photoreceptor 4, the content of the ultraviolet absorbent was 0.03% by weight based on the weight of the charge transport material.

### (Preparation of Comparative Photoreceptor 5)

Comparative Photoreceptor 5 was prepared in the same manner as in photoreceptor 2, except that the ultraviolet absorbent content was changed to 78.8 parts. In the comparative photoreceptor 4, the content of the ultraviolet absorbent was 35.0% by weight based on the weight of the charge transport material.

### (Evaluation)

The photoreceptors 1 through 18 and comparative photoreceptors 1 through 5 were mounted on a copier in which a full color multi-functional peripheral available on the market bizhub PRO C6500 (manufactured by Konica Minolta Business Technologies, Inc.) was modified, and the following evaluation was carried out.

Herein, the copier used for evaluation was one which was modified so that the exposure light spot diameter was adjusted with an aperture and in which the imagewise exposure source was exchanged to a semiconductor laser having an emission wavelength of 405 nm.

Tests carried out employing photoreceptors 1 through 18 falling within the constitution of the invention were referred to as examples 1 through 18, respectively, and tests carried out employing comparative photoreceptors 1 through 5 falling outside the constitution of the invention as comparative examples 1 through 5, respectively.

### Process Conditions for Evaluation

### Initial Charging Electric Potential

Charging current and grid voltage were adjusted so that charging electric potential of the photoreceptors was −750 v.

### Transfer Conditions

The charging roller of the intermediate transfer belt was adjusted so that transfer current was changed to 20 μA, 30 μA (ordinary condition) and 40 μA.

### (Evaluation Items and Evaluation Criteria)

(Evaluation 1: Measurement of Electric Potential after Exposure)

One hundred thousand sheets of A4 size paper were continuously printed at 30° C. and at 85% RH. Electric potential after exposure Vi before and after the continuous printing was measured. After an image was repeatedly formed at high speed, variation of exposure electric potential after exposure was determined and evaluated as a measure of durability. Herein, the electric potential after exposure was that obtained when laser light intensity of the above copier used for evaluation was maximum.

### (Evaluation 2: Evaluation of Thin Line Reproduction)

A line latent image of one dot was formed at 23° C. and at 50% RH, the exposure light spot size being changed to be 10 μm, 25 μm and 50 μm. The resulting latent image was developed, and transferred to a transfer sheet to form a line image on the transfer sheet. The line width of the line image was measured through a digital hi-scope (manufactured by KEYENCE Co., Ltd). Then, a rate of change of toner image Te was determined, and the thin line reproduction at a small size exposure light spot was evaluated according to the following criteria. The rate of change of toner image, Te refers to a rate of the line width of the toner line image to the exposure light spot size, and was computed employing the following equation.

Rate of change of toner image Te (%)=Line width (μm) of toner line image×100/Exposure light spot size (μm)

Evaluation was conducted according to the following criteria, and rankings A, B and C were judged as acceptable.

### A: 80%<Te=120%

### B: 120%<Te=167%

### C: 167%<Te

D: The Te value does not satisfy A, B, and C above.

### (Evaluation 3: Evaluation of Memory Resistance)

One hundred thousand sheets of A4 size paper were continuously printed at 30° C. and at 85% RH, and then electric potential after exposure was measured. The transfer current being changed to 20 RA, 30 μA and 40 μA, ten sheets were continuously printed employing the full color multi-functional peripheral to form an image with solid black and solid white, and successively, a uniform half-tone image was printed. Whether the solid black and solid white are found in the half-tone image printed was observed. Memory resistance was judged according to the following criteria, and evaluated as a measure of durability.

A: No memory generates (which is excellent).
B: A slight memory generates, which is of practical use (practicable).
C: Apparent memory generates, which is of no practical use (impractical).

The results are shown in Table 1.

TABLE 1

| | | Charge generation | Charge transport layer | | |
|---|---|---|---|---|---|
| | | layer | | | Ultraviolet absorbent |
| No. | PR. No. | CGM | Binder resin | CTM | (weight %)*¹ |
| Ex. 1 | PR. 1 | Y-TiOPc | 1-1 | A-8 | UV-1 (5.3) |
| Ex. 2 | PR. 2 | CG 12 | 1-1 | A-8 | UV-1 (5.3) |
| Ex. 3 | PR. 3 | CG 18 | 1-1 | A-8 | UV-1 (5.3) |
| Ex. 4 | PR. 4 | CG 18 | 1-2 | A-8 | UV-1 (5.3) |
| Ex. 5 | PR. 5 | CG 18 | 1-2 | A-29 | UV-1 (5.3) |
| Ex. 6 | PR. 6 | CG 18 | 1-10 | A-29 | UV-1 (5.3) |
| Ex. 7 | PR. 7 | CG 18 | 1-12 | A-29 | UV-1 (5.3) |
| Ex. 8 | PR. 8 | CG 18 | 1-15 | A-29 | UV-1 (5.3) |
| Ex. 9 | PR. 9 | CG 18 | 1-2 | A-13 | UV-1 (11.1) |
| Ex. 10 | PR. 10 | CG 18 | 1-2 | A-15 | UV-1 (11.1) |
| Ex. 11 | PR. 11 | CG 18 | 1-2 | A-28 | UV-1 (11.1) |
| Ex. 12 | PR. 12 | CG 18 | 1-2 | A-29 | UV-2 (11.1) |
| Ex. 13 | PR. 13 | CG 18 | 1-2 | A-29 | UV-15 (11.1) |
| Ex. 14 | PR. 14 | CG 18 | 1-2 | A-29 | UV-17 (11.1) |
| Ex. 15 | PR. 15 | CG 12 | 1-1 | A-8 | UV-1 (0.1) |
| Ex. 16 | PR. 16 | CG 12 | 1-1 | A-8 | UV-1 (29.8) |
| Ex. 17 | PR. 17 | CG 12 | 1-1 | A-8 | UV-1 (3.0) |
| Ex. 18 | PR. 18 | CG 12 | 1-1 | A-8 | UV-1 (15.0) |
| Com. Ex. 1 | Com. PR. 1 | CG 12 | PC-1 | A-8 | UV-1 (5.3) |
| Com. Ex. 2 | Com. PR. 2 | CG 12 | 1-1 | CTM-A | UV-1 (5.3) |
| Com. Ex. 3 | Com. PR. 3 | CG 12 | 1-1 | A-8 | — |
| Com. Ex. 4 | Com. PR. 4 | CG 12 | 1-1 | A-8 | UV-1 (0.03) |
| Com. Ex. 5 | Com. PR. 5 | CG 12 | 1-1 | A-8 | UV-1 (35.0) |

| | | Electric | | | |
|---|---|---|---|---|---|
| | | Potential properties | | | |
| | | Vi | Vi | Image properties | |
| | | initial | after printing | Thin Line | Memory |
| No. | PR. No. | (−V) | (−V) | Reproduction | Resistance |
| Ex. 1 | PR. 1 | 103 | 125 | B | A |
| Ex. 2 | PR. 2 | 83 | 112 | B | A |
| Ex. 3 | PR. 3 | 72 | 104 | B | A |
| Ex. 4 | PR. 4 | 73 | 94 | B | A |
| Ex. 5 | PR. 5 | 70 | 79 | A | A |
| Ex. 6 | PR. 6 | 75 | 86 | A | A |
| Ex. 7 | PR. 7 | 82 | 98 | B | A |
| Ex. 8 | PR. 8 | 83 | 99 | B | A |
| Ex. 9 | PR. 9 | 82 | 110 | B | A |
| Ex. 10 | PR. 10 | 81 | 92 | A | A |
| Ex. 11 | PR. 11 | 82 | 90 | A | A |
| Ex. 12 | PR. 12 | 71 | 80 | A | A |
| Ex. 13 | PR. 13 | 70 | 81 | A | A |
| Ex. 14 | PR. 14 | 72 | 83 | A | A |
| Ex. 15 | PR. 15 | 82 | 125 | C | B |
| Ex. 16 | PR. 16 | 101 | 123 | C | A |
| Ex. 17 | PR. 17 | 84 | 118 | B | A |
| Ex. 18 | PR. 18 | 85 | 114 | B | A |
| Com. Ex. 1 | Com. PR. 1 | 105 | 158 | C | C |
| Com. Ex. 2 | Com. PR. 2 | 258 | 328 | D | C |
| Com. Ex. 3 | Com. PR. 3 | 84 | 278 | B | C |
| Com. Ex. 4 | Com. PR. 4 | 86 | 234 | C | C |
| Com. Ex. 5 | Com. PR. 5 | 115 | 168 | D | A |

Ex.: Example;
Com. Ex.: Comparative Example;
PR.: Photoreceptor;
Comp. PR.: Comparative photoreceptor;
CGM: Charge generation material;
CTG: Charge transport material;
Y-TiOPc: Y-type titanyl phthalocyanine,
*¹Weight % based on the weight of the charge transport material

As is apparent from Table 1, the photoreceptors 1 through 18, which are the electrophotographic photoreceptors having the constitution of the invention, exhibit high thin line reproduction with a small diameter exposure light spot and excellent durability, wherein even when an image is repeatedly formed at high speed, exposure electric potential variation is reduced and image memory generation is prevented, whereby a stable image is obtained for a long period.

### EXPLANATION OF THE SYMBOLS

10Y, 10M, 10C, 10Bk: Image formation apparatus
1Y, 1M, 1C, 1Bk: Photoreceptor
2Y, 2M, 2C, 2Bk: Charging device
3Y, 3M, 3C, 3Bk: Exposing device
4Y, 4M, 4C, 4Bk: Developing device

1. An electrophotographic photoreceptor comprising an electrically conductive support and provided thereon, a charge generation layer and a charge transport layer in that order, wherein the charge transport layer contains a resin having a repeating unit represented by the following formula (1), a charge transport material represented by the following formula (2), and an ultraviolet absorbent in an amount of from 0.1 to 30.0% by weight based on the weight of the charge transport material, 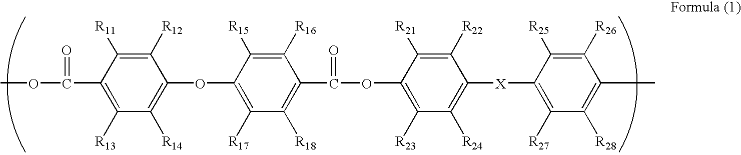
wherein R₁₁ through R₁₈ and R₂₁ through R₂₈ independently represent a hydrogen atom, an alkyl group, an aryl group or an alkoxy group; X represents a simple bond, an oxygen atom, a sulfur atom, or a divalent group having a structure represented by the formula (A), 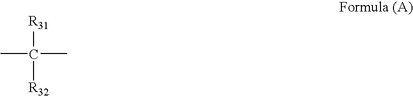
wherein R₃₁ and R₃₂ independently represent a hydrogen atom, an alkyl group, a fluorinated alkyl group, an aryl group or an alkoxy group, or R₃₁ and R₃₂ combine with each other to form a cycloalkylidene group or a fluorenylidene group, 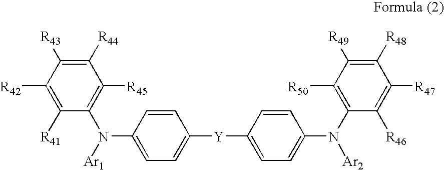
wherein R₄₁ through R₅₀ independently represent a hydrogen atom, an alkyl group, an aryl group or an alkoxy group; Ar₁ and Ar₂ independently represent an aromatic hydrocarbon group which may have a substituent; Y represents a divalent group having a structure represented by the following formula (B), 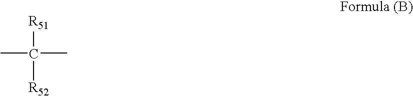
wherein R₅₁ and R₅₂ independently represent a hydrogen atom, an alkyl group, a fluorinated alkyl group, an aryl group or an alkoxy group, or R₅₁ and R₅₂ combine with each other to form a cycloalkylidene group or a fluorenylidene group.

2. The electrophotographic photoreceptor of claim 1, wherein the ultraviolet absorbent has an absorption peak in the wavelength region of from 325 to 390 nm.

3. The electrophotographic photoreceptor of claim 1, wherein the ultraviolet absorbent is a benzotriazole ultraviolet absorbent, a benzophenone ultraviolet absorbent or a triazine ultraviolet absorbent.

4. The electrophotographic photoreceptor of claim 1, wherein the thickness of the charge transport layer is from 10 to 30 μm.

5. The electrophotographic photoreceptor of claim 1, wherein the charge generation layer contains a charge generation material which is an azo pigment, a perylene pigment or a polycyclic quinone pigment.

6. The electrophotographic photoreceptor of claim 1, wherein the thickness of the charge generation layer is from 0.3 to 2 μn.

7. An image formation apparatus which repeatedly forms an image, the image formation apparatus comprising an electrophotographic photoreceptor, and provided at the circumference of the electrophotographic photoreceptor, at least a charging device, an exposing device and a developing device, wherein the exposing device is a digital mode imagewise exposing device employing a semiconductor laser or a light-emitting diode and the electrophotographic photoreceptor is an electrophotographic photoreceptor comprising an electrically conductive support and provided thereon, a charge generation layer and a charge transport layer in that order, wherein the charge transport layer contains a resin having a repeating unit represented by the following formula (1), a charge transport material represented by the following formula (2), and an ultraviolet absorbent in an amount of from 0.1 to 30.0% by weight based on the weight of the charge transport material, 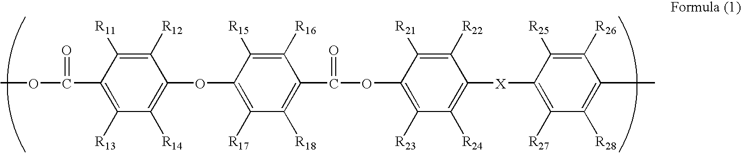
wherein R₁₁ through R₁₈ and R₂₁ through R₂₈ independently represent a hydrogen atom, an alkyl group, an aryl group or an alkoxy group; X represents a simple bond, an oxygen atom, a sulfur atom, or a divalent group having a structure represented by the formula (A), 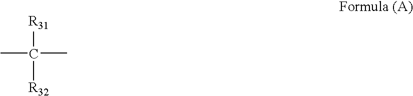
wherein R₃₁ and R₃₂ independently represent a hydrogen atom, an alkyl group, a fluorinated alkyl group, an aryl group or an alkoxy group, or R₃₁ and R₃₂ combine with each other to form a cycloalkylidene group or a fluorenylidene group, 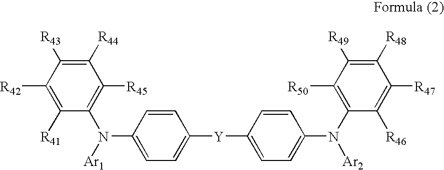
wherein R₄₁ through R₅₀ independently represent a hydrogen atom, an alkyl group, an aryl group or an alkoxy group; Ar₁ and Ar₂ independently represent an aromatic hydrocarbon group which may have a substituent; Y represents a divalent group having a structure represented by the following formula (B), 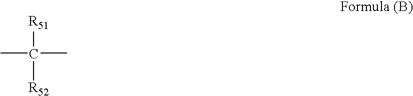
wherein R₅₁ and R₅₂ independently represent a hydrogen atom, an alkyl group, a fluorinated alkyl group, an aryl group or an alkoxy group, or R₅₁ and R₅₂ combine with each other to form a cycloalkylidene group or a fluorenylidene group.

8. The image formation apparatus of claim 7, wherein the wavelength of the semiconductor laser or the light-emitting diode is from 380 to 450 nm.
